(19) United States
(12) Patent Application Publication
(10) Pub. No.: US 2004/0252496 A1
(43) Pub. Date: Dec. 16, 2004

(54) User assembled flashlight

(76) Inventors: David R Dalton, Turramurra (AU); Robert John Smith, Rozelle (AU); Gregory James Mayer, Robertson (AU)

Correspondence Address: ROBERT W WELSH, EVEREADY BATTERY COMPANY INC, 25225 DETROIT ROAD, P O BOX 450777, WESTLAKE, OH, 44145

(21) Appl. No.: 10/240,647

(22) PCT Filed: Apr. 11, 2001
(86) PCT No.: PCT/AU01/00416

(30) Foreign Application Priority Data
Apr. 12, 2000 (AU) PQ 6858

(51) Int. Cl. F21L 4/04

(52) U.S. Cl. 362/198; 362/200; 362/202; 362/368

(57) ABSTRACT

The present invention provides a collapsed flashlight preform having a generally planar foldable portion to form a flashlight body, said foldable portion having a main portion to form the sides of a flashlight body and two end portions adapted to serve as end pieces of a flashlight when assembled; a lamp means attached to one of said two end portions; at least one battery secured to said preform by a holder; said holder having external formations thereon to support said main portion between said end pieces when said flashlight is assembled.

### FIELD OF THE INVENTION

The present invention relates to flashlights particularly those which are assembled by the user from an disassembled or collapsed state.

### BACKGROUND OF THE INVENTION

Pre-assembled flashlights can be relatively costly items and are not readily adapted to be able to be used as promotional give aways or in “disposable” situations where a one time use is required.

### SUMMARY OF THE INVENTION

The present invention provides a collapsed flashlight preform having a generally planar foldable portion to form a flashlight body, said foldable portion having a main portion to form the sides of a flashlight body and two end portions adapted to serve as end pieces of a flashlight when assembled;

a lamp means mounted on said preform;

at least one battery secured to said preform by a holder;

said holder having external formations thereon to support said main portion between said end pieces when said flashlight is assembled.

Preferably said lamp means is held by a reflector mounted to one of said two end portions.

The two end portions can include formations to engage parts of said main portion. The formations can be used to interlock said two end portions and said main portion. Preferably the formations are apertures in the main portions which receive tab formations on said two end portions.

The end portions can each be of similar shape but of different size. Preferably the flashlight formed therefrom has a tapered construction.

The preform can be adapted to receive printed matter.

Preferably a switch means is provided in said preform to switch on or off said flashlight once said flashlight is formed, with the switch being biased to the off position.

The holder can hold one or more batteries against said main portion. Preferably said holder is made from an injection moulding

Preferably a contact extends away from said battery to engage a terminal on said lamp means.

Preferably said switch is activated by a button formed on or being the end of a tongue, said tongue being secured to said preform by an annular formation integrally formed therewith, said annular formation being secured to a front end portion around an aperture from which light is to be emitted. The button can be biased to an off position when said tongue is bent relative to said annular formation when said front end portion is rotated relative to said main portion.

The bulb is preferably not connected to said battery, until said end portion having said lamp means is rotated to approximately 90° to said main position.

A switch can be formed by a biased contact which is moved by a tongue member hinged to said main portion. The tongue member can be held within said main body until said flashlight is assembled. It is preferably held by a partial perforation or separation of said tongue member from said main body. The tongue member can be released from said main body by the action of rotating said end portion having said lamp means is rotated to approximately 90° to said main portion. The lamp means can engage a switch contact to push said tongue member away from said main body. The tongue member can be formed from a portion of said main body and a portion of said holder. The portions on said main body and said holder are laminated or adhered together.

The battery holder can include one or more formations to receive said at least one battery. The battery holder can include a reflector cover or lens. The reflective cover or lens is preferably offset or depressed from a base of said battery holder. The reflector cover or lens can be used to locate said battery holder on said main portion. The reflector cover or lens includes location means to locate said lamp means or reflector having said lamp means. The location means are preferably cut outs which are engaged by projections on said lamp means or reflector having said lamp means.

The generally planar foldable portion can be made from any one of the following: cardboard; thin cardboard, polymeric material, sheet metal, polystyrene.

The present invention also provides a flashlight made from a preform as described above.

### BRIEF DESCRIPTION OF THE DRAWINGS

Embodiments of the present invention will now be described, by way of example only, with reference to the accompanying drawings in which:

FIG. 1 is in a perspective view of a flashlight according to the invention;

FIG. 2 is a perspective view of a preform from which the apparatus FIG. 1 is formed;

FIG. 3 is a preform of FIG. 2 with a first stage in the assembly process applied to it;

FIG. 4 is the next step in the assembly process of a flashlight;

FIG. 5 is the perspective view of the finished product similar to that of FIG. 1;

FIG. 6 is an exploded view of the assembly process of a flashlight similar to that of FIG. 1;

FIG. 7 illustrates a cross section through an assembled flashlight of FIG. 6;

FIG. 8 illustrates a plan view of a blank from which the preform for the flashlight of FIGS. 6 and 7 is be made;

FIG. 9 illustrates a plan view of the battery holder for use in the flashlight of FIG. 6 and 7;

FIG. 10 illustrates a left side view of the battery holder of FIG. 9:

FIG. 11 illustrates a side elevation of the battery holder of FIG. 9;

FIG. 12 illustrates a half rear view of the battery holder of FIG. 9;

FIG. 13 illustrates a flashlight and assembly method utilising an LED;

FIG. 14 illustrates a front view of a reflector for use with the flashlight FIG. 6; and

FIG. 15 illustrates a side view of the reflector of FIG. 14 with a lamp in place.

### DETAILED DESCRIPTION OF THE EMBODIMENTS

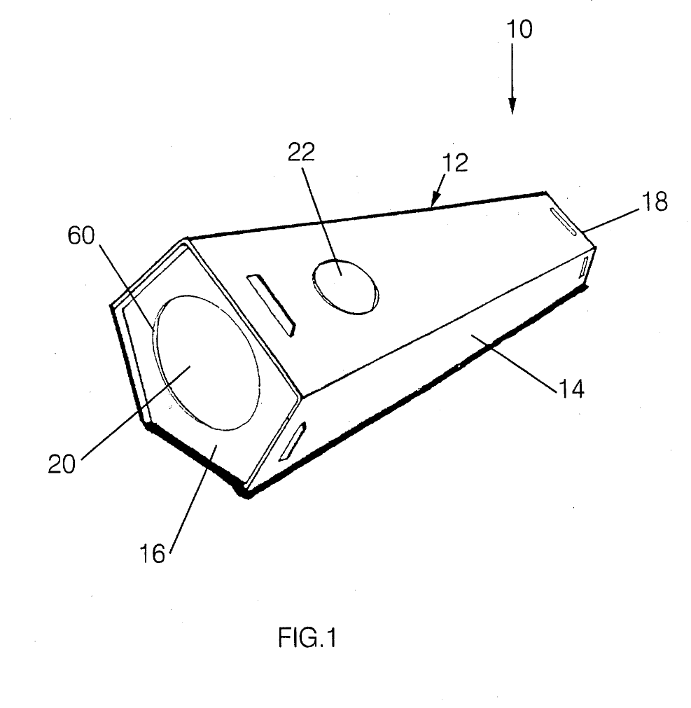

Illustrated in FIG. 1 is a flashlight 10 having a cardboard or thin plastic body 12 made up of 5 similarly shaped side panels 14, a front end panel 16, a rear end panel (not visible), a reflector 20 and a moveable button 22 (which acts as a switch) on an external side thereof. The flashlight 10 is constructed from a cardboard or plastic preform of a generally planar nature as will now be described in detail.

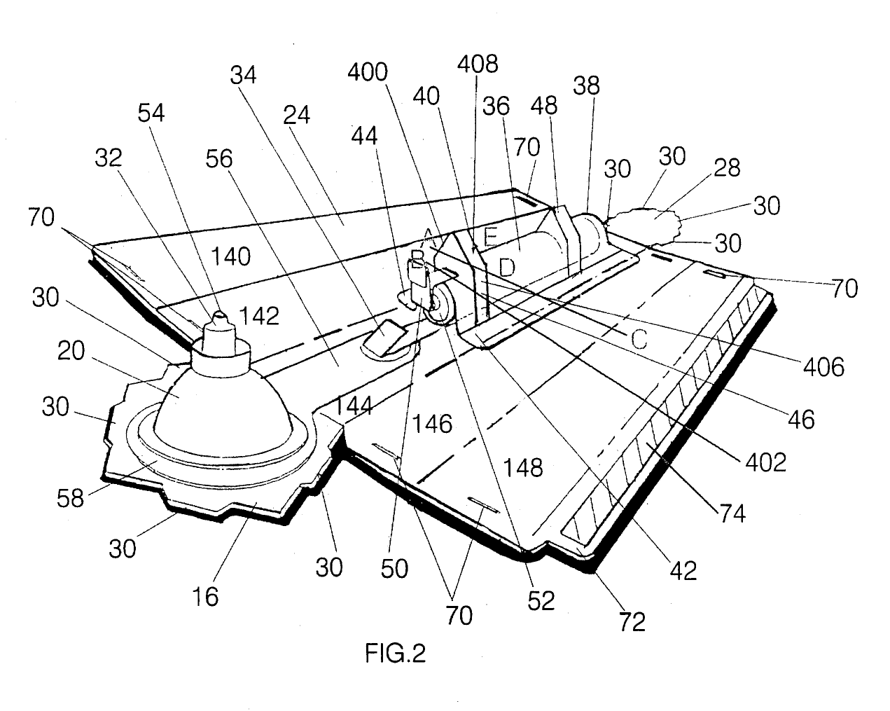

Illustrated in FIG. 2 is a preform 24 from which the flashlight 10 is formed. The Preform 24 has panels 140, 142, 144, 146 and 148. Each of the panels 140, 142,144, 146 and 148 are of a similar shape. As can be seen in FIG. 2 each panel 140, 142,144, 146 and 148 has a tapered shape wherein the forward end (that end near to the reflector 20) is of a larger dimension than the rear end.

The panels 140, 142,144, 146 and 148 forms a main portion of the preform 24. This main portion has integrally formed with it a front end panel 16 and a rear end panel 28. The panels 16 and 28 are of a generally pentagonal shape with one side of the pentagon joining with the panel 144. Each panel 16 and 28 has four free sides and each free side has a tab 30 whose purpose will be discussed in more detail later.

The reflector 20 includes a lamp 32 which is preferably of a non-replaceable type and is preferably irretrievably secured to the reflector 20 so that the lamp 32 and reflector 20 cannot be separated.

A base electrical contact 34 passes along a length of the panel 144 under a battery 36 to contact the negative end 38 of the battery 36. The contact 34 is glued to the panel 144 and the battery 36 held in place by a holder 40 which is secured by side flanges 44 and 42 to the panel 144.

The holder 40 has two raised formations 46 and 48. The formations 46 and 48 have four sides 402, 400, 408 and 406. When the flashlight is assembled the sides 400 and 408 will support the panels 142, and 148 which will lie adjacent thereto, when the panels 142, 140, 148 and 146 are folded around the formations 46 and 48. The formations 46 and 48 by preventing the joined edges of panels 142 and 148 from moving towards the panel 144 will provide a sufficient degree of rigidity or sturdiness for the cardboard flashlight 10 to function as a flashlight.

A positive contact 50 is provided which is held by the formation 46 and extends away form it, to make contact with the positive terminal 52 of the battery 36 and with the positive terminal 54 on the lamp 32. In use the button 22 which is formed on a tongue 56 can be pushed into the body 12 so as to force the terminal 34 into contact with a metallised exterior of reflector 20 thereby forming a circuit with the lamp 32 and the battery 36 to enable the lamp 32 to be illuminated.

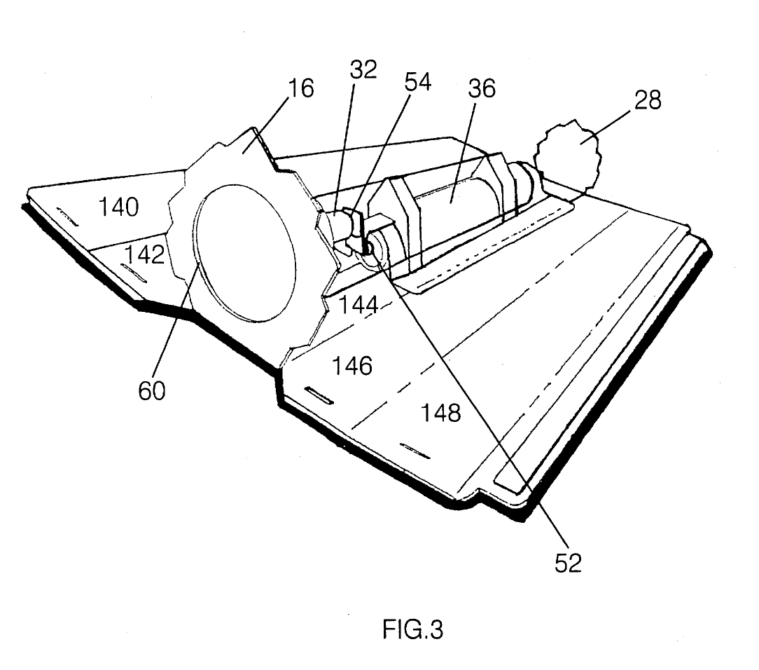

The tongue 56 is not secured to the panel 144. Instead an annular portion 58 is attached to the panel 16 and surrounds the aperture 60 in the panel 16 so that when panel 16 is folded to a position approximately perpendicular to the panel 144 as illustrated in FIG. 3, the tongue 56 will be bent at approximately right angles to the annular portion 58. This bending of the tongue 56 relative to annular portion 58 will generate a bias on the tongue 56 to push against the panel 144. This bias together with the natural bias provided by the terminal 34 will tend to keep the terminal 34 out of contact with the metallised body of the reflector 20.

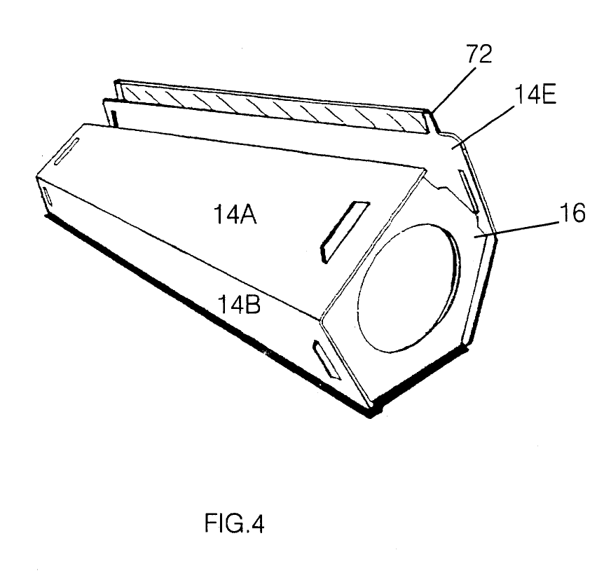

As can be seen in FIG. 3 once the panel 16 is rotated to 90° the positive terminal 54 of the lamp 32 makes contact with the terminal 50 which in turn is contacting the positive terminal 52 of the battery 36. The other end 28 is also folded so as to be at approximately right angles to the panel 144 and from these positions the preform can proceed to the next stage of assembly as illustrated in FIG. 4.

As illustrated in FIG. 4 the next stage consists of the panels 140, 142, 146 and 148 being folded around the panels 16 and 28 and the formation 46 and 48 so that apertures 70 at either end of each of the panels 140, 142, 146 and 148 will receive the tabs 30 on each of the panels 16 and 28 and pass therethrough. Once all the panels 140, 142, 146 and 148 have had the tabs 30 pass through them, the longitudinal tab 72, which has an adhesive band 74 (maybe either double sided tape or an adhesive covered with a peel off cover), is folded. After the tab 72 has its cover 74 peeled off, the tab 72 can be adhered to the external surface of the panel 140 to render the appearance as in FIG. 5.

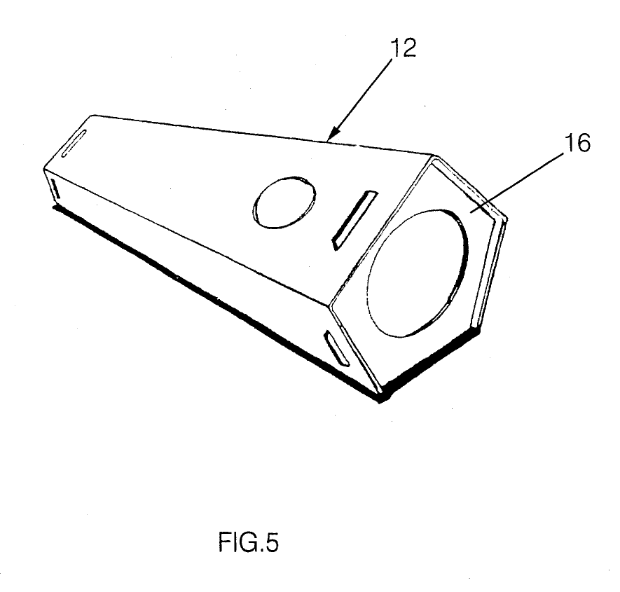

Illustrated in FIG. 6 is a flashlight 200 which is similar to the flashlight 10 of previous figures. Many features of the flashlight 200 are similar to those of the flashlight 10. Some similar features are those in FIG. 6 which are numbered by a 200 series number with the tens and units number corresponding to a tens and units number in FIGS. 1 to 5.

The main differences between the flashlight 200 and flashlight 10, among other things are that the battery holder 240 includes some improvements as does the switching mechanism.

The flashlight 200 has the components as illustrated in FIG. 6 pre-assembled to the blank 211 with the final assembly steps as described in relation to FIGS. 1 to 4 being performed by the user.

The preform or partially assembled flashlight 200 will be manufactured so that the bulb 232 is assembled to the reflector 220 by hot melt gluing the two together. The next stage in the assembly procedure requires a double sided tape annulus 22, to be attached to the rim of the reflector 220.

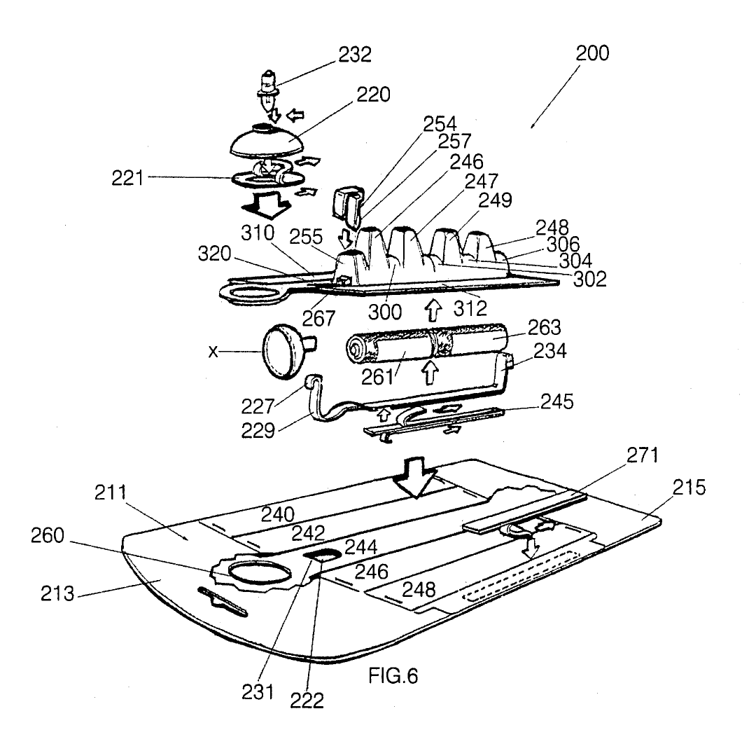

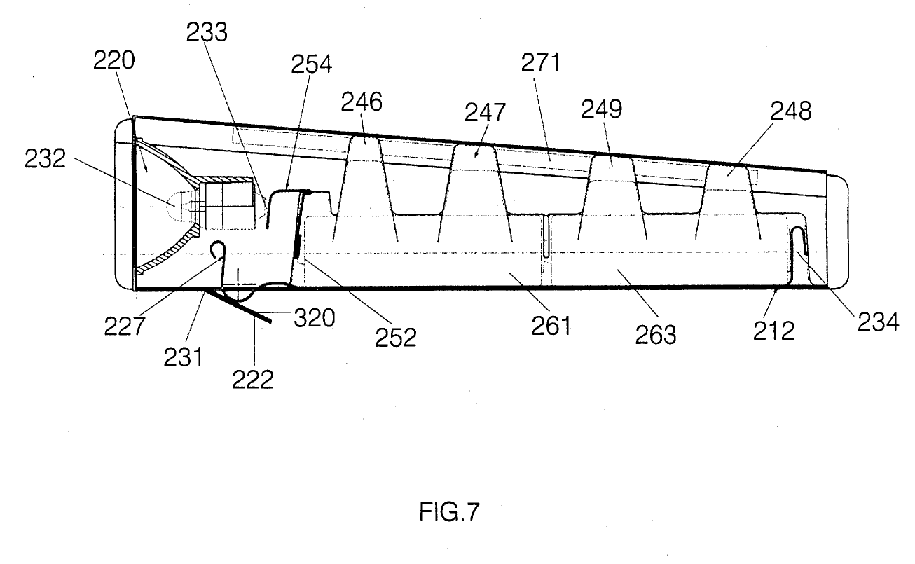

To construct the rest of the preform the battery holder 240 receives the positive battery contact 254 inside the forward most formation 255 of the battery holder 240. As can be seen from FIG. 7 the positive terminal 254 has its rearward portion 257 lying adjacent the forward wall of the formation 255. As also can be seen from FIG. 7 the positive terminal 252 of the battery 261 rests against the portion 257.

The batteries 261 and 263 are then inserted into the battery holder 240 from underneath the battery holder 240. The negative terminal and switch contact 234 is also then passed through the aperture 267 at the base of the formation 255 with the rear end of contact 234 engaging the negative terminal of rear battery 263. Once positioned the portion 229 of contact 234 will be resting against flap or tongue 230. The portion 229 will force the flap 320 away from the portion of the battery holder 240 in which it is located because the flap 320 is disconnected from the battery holder 240, except for the connection by hinge 231.

The base of the contact 234 has double sided tape attached to it. When the battery holder 240 and its contents (batteries 261,263, contacts 234 and 254) are to be attached to body 212, the second side of the double sided tape is removed and the base of contact 234 adhered to body 212. During this sub-assembly a protective cover can be placed on the end 227 of the contact 234.

The electrical circuit is preferably tested before assembling the battery holder 240 to the body 212 contained within the blank 211. This testing is done by using a spare reflector and lamp designated by the letter ‘X’ in FIG. 6, to connect to the terminals,227 and 254 to ensure that the batteries and the contacts with portion 257 and the rear end of contact 234 are satisfactory

The protective cover is then removed from the end 227 and the battery holder 240 and its assembled contents (batteries 261, 263, contacts 234 and 257) are placed on the body 212 and onto panel 244 so that the portion 229 of the contact 234 nests against the switching flap 222. The switching flap 222 is only partially perforated and frangible from panel 224. The partial perforation is sufficient to resist the force exerted by portion 229, however will fully perforate when the user assembles the flashlight as described below.

The battery holder, preferably manufactured from PET, is then heat stomped or stamped to the body 212. This process is sometimes called face sealing and is performed by the application of heat and pressure. It is a process which is commonly used in the formation of blister packaging. The battery holder 240 is effectively a blister package and is relatively inexpensive to manufacture.

The other side of the double sided tape annulus 221 is then removed and the reflector involved attached around the aperture 260. Another piece of double sided tape 271 is then attached to the edge of the body 212. The first stage in the user assembly process is to remove the ends 213 and 215 from the blank 211 leaving just the body 212 whereupon the assembly procedure described above in relation to FIGS. 1 to 5 can be effected.

As can be seen from FIGS. 6 and 7 the battery holder 240 has four raised formations 246, 248 and 247 and 249. As the flashlight 200 of FIG. 6 and 7 utilises two batteries 261 and 263, the length of the body 212 is longer than that of the first embodiment and thus greater support along the length of the panels, 240, 242, 244, 246 and 248 is required to give a sturdy feel to the final assembled product.

As can be seen from FIG. 7 once the flashlight 200 is assembled the portion 229 of contact 234 forces the switch flap 222 to protrude downwardly. By the switch flap 222 being pivoted at 231 to the body 212 some mechanical advantage is provided to push the end 227 into contact with the globe body 232. In use the contact 254 will be engaging the contact 233 on the lamp 232.

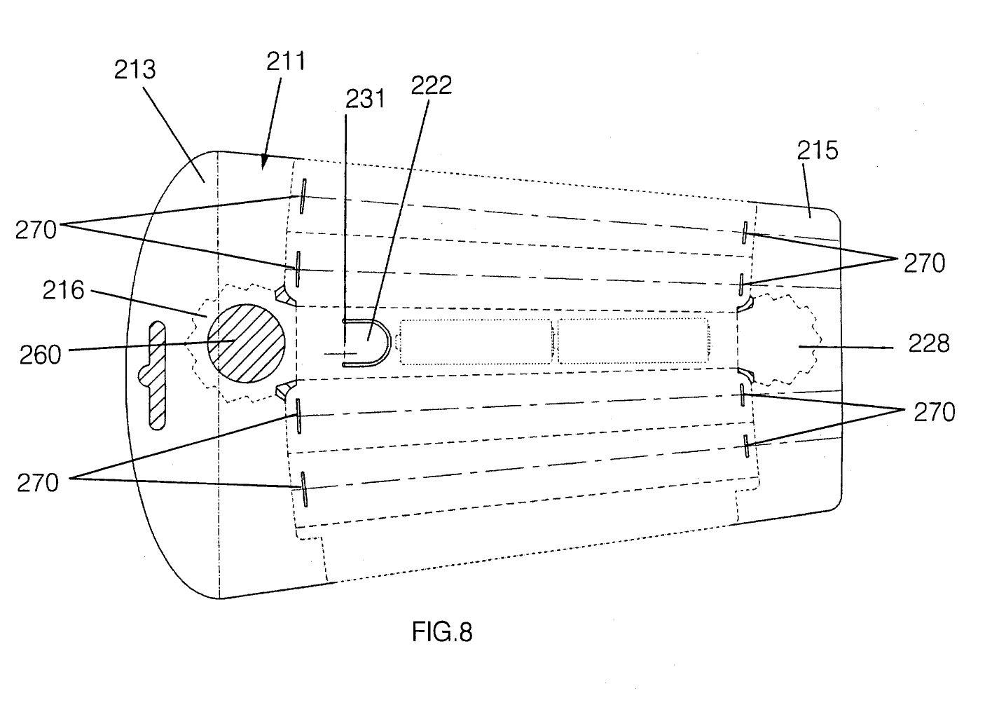

As illustrated in FIG. 8 is a plan view of the blank 211 of FIG. 6 showing the location of the batteries 261 and 263. The blank 211 will have on the side illustrated in FIG. 8 instructions on how to assemble the flashlight 200, while the other side the blank 211 can bear the advertising and logos of an organisation which may give away the flashlight as part of a promotional exercise. Preferably the user assembly instructions are included on the tear off ends 215 or 213 so the instructions can be visible to the user whilst assembling.

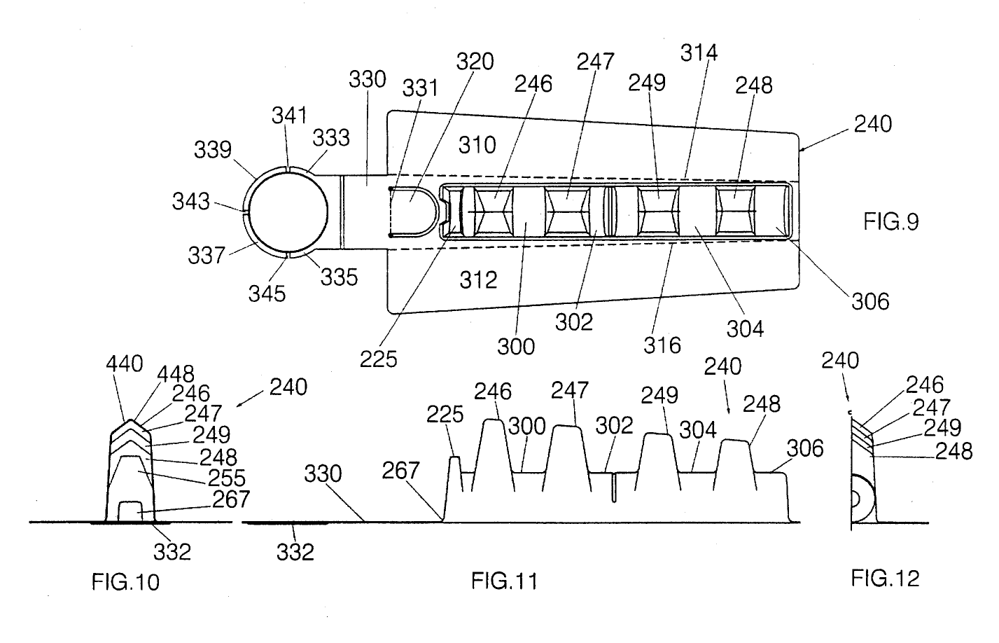

Illustrated in more detail in FIGS. 9 to 12 is the battery holder 240. The battery holder 240 comprises the forward formation 255 and raised formations 246, 247, 249 and 248. Between the formations 246, 247, 249 and 248 are curved portions 300, 302 and 304 respectively. The end of battery holder 240 has a curved portion 306 as well. The curved portions 300, 302, 304 and 306 each have a top section which is semi-circular in cross section so as to match closely the shape of batteries 261, 263 (as illustrated in FIG. 12) so as to sandwich the batteries 261 and 263 between the holder 240 and the length of the contact 234, thus the body 212.

The forward portion 255 includes the forward aperture 267 through which the electrical contact 234 can pass. The battery holder 240 has side panels 310 and 312, which by virtue of attachment to the panels 242 and 246, will hold the battery holder 240 onto the body 212. The battery holder 240 will be folded along the lines 314 and 316 when assembled. To make the folding process easier the lines 314 and 316 are preferably perforated to decrease the amount of material that has to be bent.

The battery holder 240 also includes a flap portion 320 which overlies the switch flap 222 before assembly by the user. The flap 320 is disconnected from the battery holder 240, other than along the hinge 331. The switch flap 222 is also connected to the body 212 prior to assembly by the user. The switch flap 222 and the flap portion 320 assume the position as illustrated in FIG. 7 by the user rotating the reflector by approximately 90° from the position illustrated in FIG. 2 to the position illustrated in FIG. 3 which causes the body of the lamp 232 to push the end 227 of contact 234 in a downward direction as illustrated in FIG. 7. This causes the flap 222 to break away from the body 212 whilst remaining hingedly connected.

The battery holder 240 at its forward end includes an extension 330 and terminates at its forward end with a lens 332 to overlay the aperture 260 on the body 212. The lens 332 is formed as a depression in the battery holder 240, as is illustrated in FIG. 10. As can be seen from FIG. 9, around the lens 332 are flanges 333, 335, 337 and 339 which can be adhered to the body 212 adjacent aperture 260. Between flanges 333, 335, 337 and 339 are cut-outs 341, 343 and 345. The purpose of these will be discussed below.

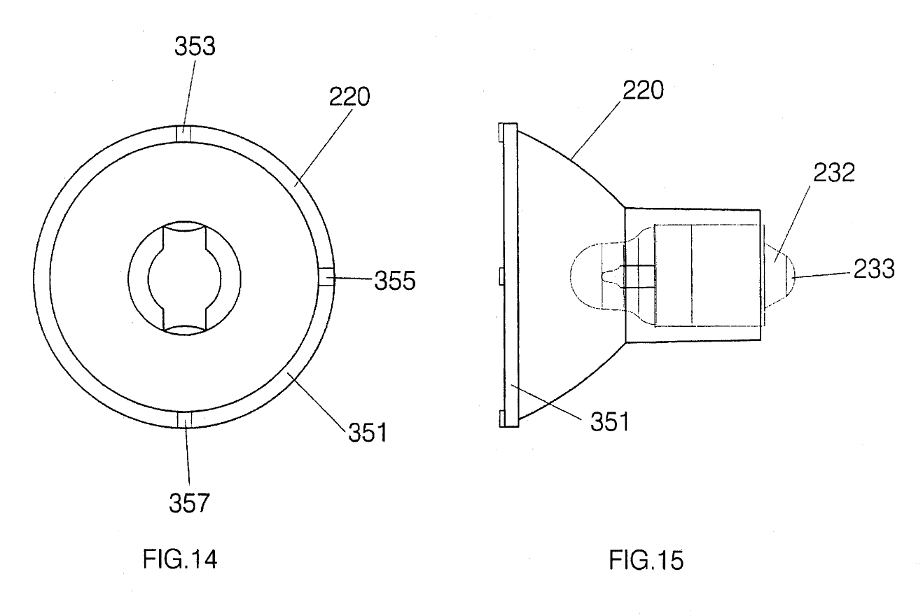

Illustrated in FIGS. 7, 14 and 15 is a sectional view, front elevation and plan view respectively of the reflector 220 for use with the flashlight 200. The rim 351 includes three tabs 353, 355 and 357. The tabs 353, 355 and 357 are able to be inserted into the cut-outs 341, 343 and 345 on the battery holder 240 so that the reflector 220 will be easily and correctly centred over aperture 260 and lens 332.

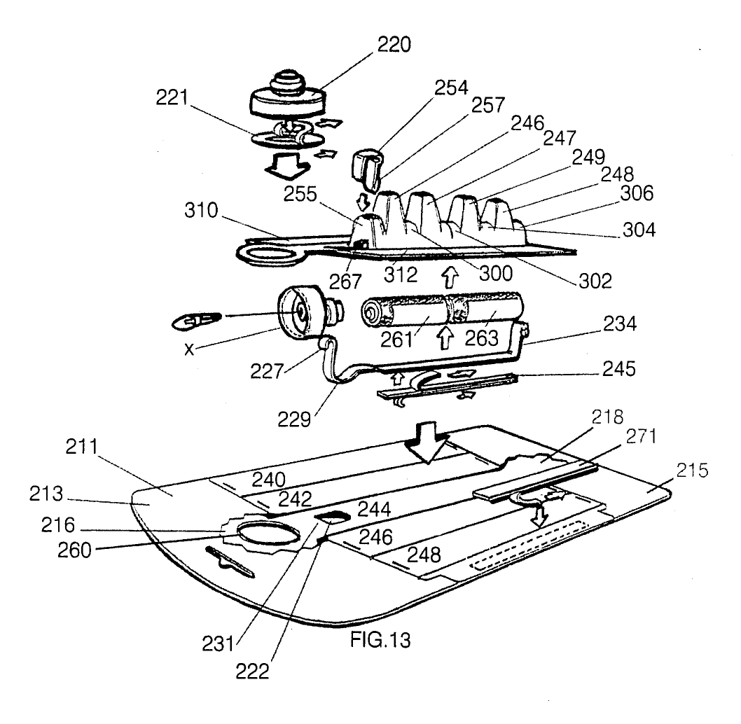

In use the panels 242, 240, 246 and 248 are folded and taped together by double sided tape 271 along overlapping edges of panels 242 and 248. This places the panels 242 and 248 over the raised formations 246,247,249 and 248. The raised formations 246, 247, 249 and 248 only make contact with the two top angled faces 440 and 448 at the top of each raised formation 246, 247, 249 and 248. The support provided by these top two faces 440 and 448 do provide sufficient rigidity or sturdiness for the flashlight 200 to meet its function requirements. Illustrated in FIG. 13 is an embodiment similar to that of FIG. 6 however the lamp 232 and reflector 220 is not utilised and an LED is used instead inside a housing similar to that of the reflector 220, so that the housing will interact with the end 227 of contact 234 to push the end 229 to break the flap 222 away from the body 212.

The tapered formation of the resultant flashlight allows a single flashlight to be held in a single hand by different aged users which can be important when the preform and flashlight are used in a promotional environment so as to give satisfaction to the user.

While the preferred method of securing the battery holder 240 and body 212 is by the face sealing of the blister package battery holder 240 to the body 212 (face sealing being a process of the application of heat and pressure) any adhering means can be used, such as double sided tape, gluing, contact adhesive, sonic welding etc.

The description above in relation to FIGS. 6 to 15 describes the flap 320 on battery holder 240 as being wholly disconnected from the battery holder 240 except along the hinge 331. If necessary, the free end of flap 320 can remain partially and frangibly connected to the battery holder 240 providing the partial frangible connection can be broken by means of the reflector 220 or the housing of FIG. 13 rotating to its use position thereby forcing the end 229 to break the connection.

The battery or batteries used can be of any suitable size and as compactness is desirable, AA or AAA batteries are most preferable.

Such flashlights 10 and 200 are thus relatively cheap to manufacture with little assembly required from the factory, and whilst an excellent for promotional purposes also has a use in such areas as tourism eg cave tours where a disposable flashlight would be helpful.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A collapsed flashlight preform having a generally planar foldable portion to form a flashlight body, said foldable portion having a main portion to form the sides of a flashlight body and two end portions adapted to serve as end pieces of a flashlight when assembled; a lamp means mounted on said preform; at least one battery secured to said preform by a holder; said holder having external formations thereon to support said main portion between said end pieces when said flashlight is assembled:

2. A collapsed flashlight preform as claimed in claim 1 wherein said two end portions include formations to engage parts of said main portion.

3. A collapsed flashlight preform as claimed in claim 2 wherein said formations interlock said two end portions and said main portion.

4. A collapsed flashlight preform as claimed in claims 2 or 3 wherein said main portion includes apertures to receive tab formations on said two end portions.

5. A collapsed flashlight preform as claimed in any one of the preceding claims wherein said end portions are each of similar shape but of different size.

6. A collapsed flashlight preform as claimed in any one of the previous claims wherein the flashlight formed therefrom has a tapered construction.

7. A collapsed flashlight preform as claimed in any one of the previous claims wherein said preform is adapted to receive printed matter.

8. A collapsed flashlight preform as claimed in any one of the previous claims wherein a switch means is provided in said preform to switch on or off said flashlight once said flashlight is formed.

9. A collapsed flashlight preform as claimed in claim 8 wherein said switch is biased to the off position.

10. A collapsed flashlight preform as claimed in any one of the previous claims wherein said holder holds at least one battery against said main portion.

11. A collapsed flashlight preform as claimed in any one of the preceding claims wherein a contact extends away from said battery to engage a terminal on said lamp means.

12. A collapsed flashlight preform as claimed in claim 8 or 9, wherein said switch is activated by a button formed on or being the end of a tongue, said tongue being secured to said preform.

13. A collapsed flashlight preform as claimed in claim 12 wherein said button is biased to an off position when said tongue is bent relative to said annular formation when said front end portion is rotated relative to said main portion.

14. A collapsed flashlight preform as claimed in any one of the preceding claims wherein said holder is made from an injection moulding.

15. A collapsed flashlight preform as claimed in any one of the preceding claims, wherein a switch is formed by a biased contact which is moved by a tongue member hinged to said main portion.

16. A collapsed flashlight preform as claimed in claim 15, wherein said tongue member is held within said main body until said flashlight is assembled.

17. A collapsed flashlight preform as claimed in claim 16, wherein said tongue member is held within said main body by a partial perforation or separation of said tongue member from said main body.

18. A collapsed flashlight preform as claimed in claim 15 or 16, wherein said tongue member is released from said main body by the action of rotating said end portion having said lamp means is rotated to approximately 90° to said main portion.

19. A collapsed flashlight preform as claimed in claim 18, wherein said lamp means engages a switch contact to push said tongue member away from said main body.

20. A collapsed flashlight preform as claimed in any one of claims 15 to 19, wherein said tongue member is formed from a portion of said main body and a portion of said holder.

21. A collapsed flashlight preform as claimed in claims 20, wherein said portions on said main body and said holder are laminated or adhered together.

22. A collapsed flashlight preform as claimed in any one of the preceding claims, wherein said holder includes one or more formations to receive said at least one battery.

23. A collapsed flashlight preform as claimed in any one of the preceding claims, wherein said holder includes a reflector cover or lens.

24. A collapsed flashlight preform as claimed in claim 23, wherein said lens or reflective cover is offset or depressed from a base of said battery holder.

25. A collapsed flashlight preform as claimed in claim 24, wherein said reflective cover or lens is used to locate said battery holder on said main portion.

26. A collapsed flashlight preform as claimed any one of claims 24 to 25, wherein said reflector cover or lens includes location means to locate said lamp means or reflector having said lamp means.

27. A collapsed flashlight preform as claimed in claim 26, wherein said location means are cut outs which are engaged by projections on said lamp means or reflector having said lamp means.

28. A collapsed flashlight preform as claimed in any one of the preceding claims, wherein said lamp means is held by a reflector mounted to one of said two end portions.

29. A collapsed flashlight preform as claimed in any one of the preceding claims, wherein said bulb is not connected to said battery, until said end portion having said lamp means is rotated to approximately 90° to said main portion.

30. A collapsed flashlight preform as claimed in any one of the preceding claims, wherein said generally planar foldable portion is made from any one of the following: cardboard; thin cardboard, polymeric material, sheet metal, polystyrene.

31. A flashlight formed from a preform as claimed in any one of the previous claims.
